(19) United States
(12) Patent Application Publication
(10) Pub. No.: US 2012/0109676 A1
(43) Pub. Date: May 3, 2012

(54) MULTIUSER HEALTH MONITORING USING BIOMETRIC IDENTIFICATION

(76) Inventor: Pierre M. Landau, Tucson, AZ (US)

(21) Appl. No.: 13/281,233

(22) Filed: Oct. 25, 2011

Related U.S. Application Data
(60) Provisional application No. 61/408,425, filed on Oct. 29, 2010.

(51) Int. Cl. G06Q 50/22

(52) U.S. Cl. 705/2

(57) ABSTRACT

A device, system and method for multiuser health monitoring includes a computer, a biometric sensor for sensing a unique trait of a user, and at least one measurement device for measuring at least one parameter of the user's health. The computer is configured to receive biometric information relating to the user from the biometric sensor and health information relating to the user from the at least one measurement device, and to associate the received biometric information with the received health information. The associated biometric information and health information is transmitted to a health monitoring data center.

### CROSS REFERENCE TO RELATED APPLICATIONS

This application claims priority from U.S. Provisional Application Ser. No. 61/408,425, filed Oct. 29, 2010.

### FIELD

The present disclosure is generally related to a device, system and method for monitoring health, utilizing biometric information for access, identification and transmission of health information. The invention has particular utility in connection with facility-based health monitoring hubs for providing health measurement and monitoring services for multiple users of the hub. The invention will be described in connection with such utility, although other utilities are contemplated.

### BACKGROUND

As median population around the world ages, there is an increase in chronic illness. In the US, more patients are treated for chronic conditions than for episodic ones. A number of studies have shown that for patients with certain chronic conditions, monitoring of simple measurements such as BP or weight, potentially coupled with some minimal patient interaction, dramatically reduces hospitalization rates.

In recent years, a number of “home hub” types of devices have emerged. These aggregate data from BP meters, scales, pulse oximeters, respiratory flow meters, and other similar devices, and forward them to a remote monitoring site. The monitoring site must correctly associate the arriving measurements with a patient in order to arrive at a reasonable recommendation for treatment. Assigning the serial number of the measuring device (such as a blood pressure meter) to a patient, then looking up the serial number when data arrives, works quite well, but presents a significant problem when two or more people in a household suffer from chronic conditions. To use a further example, in an assisted living facility with ten patients, it would be difficult to justify purchasing ten weigh scales or ten BP meters just to ensure that each patient's measurements can be easily distinguished from another's.

### SUMMARY

Embodiments of the present disclosure provide a health monitoring hub, system and method for remotely monitoring a person's health. Briefly described, the present disclosure can be viewed as providing devices, systems and methods for associating a person's measured health information with an identifier unique to that person, and transmitting the associated identification and health information to a monitoring data center.

In one aspect, the present disclosure provides a multiuser health monitoring hub which includes a computer, a biometric sensor for sensing a unique trait of a patient, and at least one measurement device for measuring at least one parameter of the user's health. The computer may be configured to receive biometric information relating to the user from the biometric sensor, and to receive health information relating to the user from the at least one measurement device. The computer may then associate the received biometric information with the received health information. The computer may further be configured to associate the biometric information relating to the user with a user identifier that is unique to the hub, and to associate the user identifier with the health information relating to the user. The user identifier may be automatically assigned by the computer. The user health information, along with the associated identifier and/or biometric information, may then be transmitted to a health monitoring data center.

In a further aspect, the present disclosure provides a multiuser remote health monitoring system which includes a multiuser health monitoring hub having a computer, a biometric sensor for sensing a unique trait of a user, at least one measurement device for measuring at least one parameter of the user's health, and a database located remote from the hub. The computer may be configured to receive biometric information relating to the user from the biometric sensor, and to receive health information relating to the user from the at least one measurement device. The computer may then associate the received biometric information with the received health information. The computer may further be configured to associate the biometric information relating to the user with a user identifier that is unique to the hub, and to associate the user identifier with the health information relating to the user. The user identifier may be automatically assigned by the computer. The user health information, along with the associated identifier and/or biometric information, may then be transmitted to a health monitoring data center.

In yet another aspect, the present disclosure provides a method of remotely monitoring a person's health, which includes the steps of: sensing a unique trait of the user, utilizing a biometric sensor; measuring at least one parameter of the person's health with at least one measurement device; receiving, by a computer, biometric information sensed by the biometric sensor and health information measured by the at least one measurement device; associating, by the computer, the received biometric information with the received health information; and transmitting the associated biometric and health information to a remotely located database.

The computer may be configured to associate the received biometric information with a unique user identifier, and to associate the user identifier with the health information relating to the user.

By utilizing biometric information to identify and/or authenticate a patient, the embodiments of the present disclosure make health monitoring systems easier to access and use, particularly for illiterate, vision impaired or other disadvantaged patients. Furthermore, by transmitting measured health information for a user with a user identifier or biometric information (as opposed to, for example, the user's actual name), the user's information is maintained in privacy, even if the transmitted information were to be intercepted.

In still yet another aspect, the present disclosure provides a non-transitory computer readable medium containing instructions for providing remote monitoring of a person's health, wherein a unique trait of a person is sensed using a biometric sensor, and at least one parameter of a person's health is measured with at least one measurement device, and wherein biometric information sensed by the biometric sensor and health information measured by the at least one measurement device, is received by the computer, the instructions, which when executed by the computer, performing the steps of associating, by the computer, the received biometric information with the received health information; and transmitting the associated biometric health information to a remotely located database.

The features, functions, and advantages that have been discussed can be achieved independently in various embodiments of the present disclosure or may be combined in yet other embodiments further details of which can be seen with reference to the following description and drawings.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is an illustration of a block diagram of a multiuser health monitoring system, in accordance with a first exemplary embodiment of the disclosure.

FIG. 2 is an illustration of a flow diagram for a method of remotely monitoring a user's health utilizing the system shown in FIG. 1, in accordance with an exemplary embodiment of the disclosure.

### DESCRIPTION

In the following description, reference is made to the accompanying drawings, which form a part hereof, and in which is shown, by way of illustration, various embodiments of the present disclosure. It is understood that other embodiments may be utilized and changes may be made without departing from the scope of the present disclosure.

Many embodiments of the invention may take the form of computer-executable instructions, including algorithms executed by a programmable computer. Those skilled in the relevant art will appreciate that the invention can be practiced with other computer system configurations as well. Certain aspects of the invention can be embodied in a special-purpose computer or data processor that is specifically programmed, configured or constructed to perform one or more of the computer-executable algorithms described below. Accordingly, the term “computer” as generally used herein refers to any data processor and includes Internet appliances, hand-held devices (including palm-top computers, wearable computers, cellular or mobile phones, multi-processor systems, processor-based or programmable consumer electronics, network computers, minicomputers) and the like.

Aspects of the invention described below may be stored or distributed on computer-readable media, including magnetic and optically readable and removable computer disks, fixed magnetic disks, floppy disk drive, optical disk drive, magneto-optical disk drive, magnetic tape, hard-disk drive (HDD), solid state drive (SSD), compact flash or non-volatile memory, as well as distributed electronically over networks. Data structures and transmissions of data particular to aspects of the invention are also encompassed within the scope of the invention.

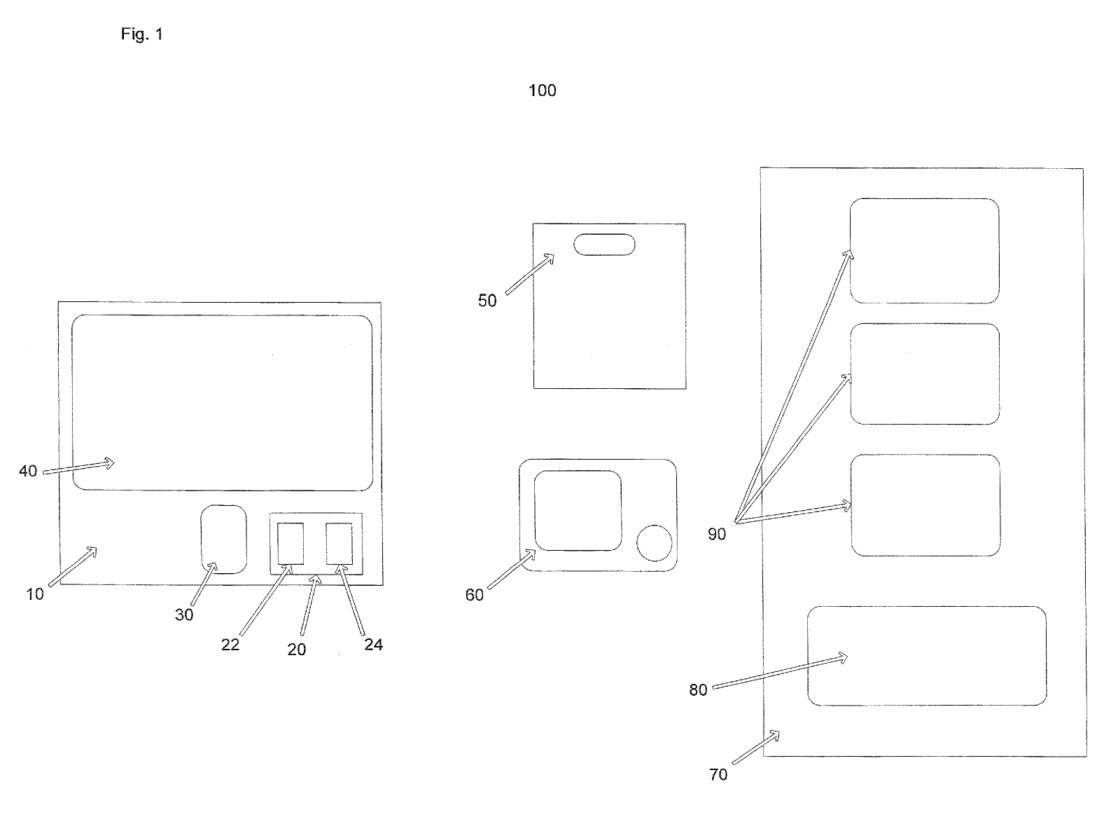

FIG. 1 illustrates a multiuser health monitoring system 100, in accordance with a first exemplary embodiment of the present disclosure. The system 100 includes a multiuser health monitoring hub 10. The hub 10 includes a computer 20, which may have a processor 22 and computer-readable memory 24. The computer 20 may be housed within the hub 10, as shown in FIG. 1, or may be provided outside of the hub 10 and in communication with the hub 10. A monitor or display 40 may be included with the hub 10, and may communicate with the computer 20. The hub 10 further includes a biometric sensor 30, which senses a unique trait of a user of the hub 10. For example, the biometric sensor 30 may be a fingerprint scanner, a retinal scanner, a voice recognition device, or the like. Humans each have unique fingerprints, retinal characteristics and voice traits, and thus may be uniquely identified based on these traits.

In order to access and use the health monitoring system 100, a person may first be required to be authenticated and/or registered via the biometric sensor 30. During an initial setup and registration process, a user may be required to register his/her fingerprint information (e.g., where the sensor 30 is a fingerprint scanner), retinal information (e.g., where the sensor 30 is a retinal scanner), voice information (e.g., where the sensor 30 is a voice recognition device) or other unique trait. The biometric sensor 30 may collect this initial biometric information, and the user may be registered based on this information. For example, the user's biometric information may be stored in memory 24. Once registered, a user may thereafter access the system 100 by allowing the sensor 30 to sense the registered trait (e.g., fingerprint, retina, voice, etc.), and the sensed information may be compared with registered biometric information stored, for example, in an identification database in memory 24. If the sensed information matches with registered information, then the user may be successfully authenticated and allowed to access the system 100.

During the initial registration of a user, the hub 10 may require that the user enter some additional user identification information which may be associated with the sensed biometric information. The user identification information may be entered utilizing the display 40, which may be a touchscreen display, or via any other known input method, such as a keyboard and/or mouse. The user identification information may be a user identifier that is unique to the hub 10. Alternatively, the hub 10 may automatically assign a user identifier to each registering user. For example, each user being set up on the hub 10 may be automatically assigned a sequence number which is associated with a position or location of their biometric information stored in the identification database internal to the hub 10.

In a further step of the registration process, the registering user (or their representative) may connect over a private or public data channel, to a remotely located data center 70, and associate the user identifier with a patient name, number, or other characteristic that would uniquely identify the user in an Electronic Health Records system, which may be stored in a database 80 in the data center 70. Additionally or alternatively, the biometric information for each user may be transmitted to the data center 70, and may be associated with a patient name, number or other identifying information for each user of the system 100. The user identifier and/or biometric information, along with the corresponding patient name, number or other identifying characteristic, may be stored in a database 80 in the data center 70. The data center 70 may include a look-up table to associate user identifiers and/or biometric information with the users' name, number or other identifying characteristics.

During operation, the user may log into the hub 10 by providing the required biometric information to the biometric sensor 30, such as by placing their finger on a fingerprint sensor. The hub 10 may display welcome messages or other prompts to the user. The hub 10 may display the user identifier or the user's name on the display 40 for confirmation that the user has properly logged in. Once authenticated, the user may use any of a variety of measurement devices, which measure some parameter of the user's health. For example, the system 100 may include a weight scale 50 and a blood pressure monitor 60. Any other health measurement devices may included with the system 100, including, but not limited to, respiratory rate monitors, heart rate monitors, pulse oximeters, vision measurement devices, blood glucose monitoring devices, and/or any other device which measures a parameter of a person's health. The health measurement devices (e.g., the scale 50 and blood pressure monitor 60) may be physically connected to the hub 10, or may communicate with the hub 10 via any wired or wireless network.

Information collected from the measurement devices 50, 60 may be tagged with the user's biometric information sensed by the biometric sensor 30 and/or stored in the memory 24. Additionally or alternatively, the data collected from the measurement devices 50, 60 for a user may be tagged with the user identification information (e.g., a sequence number which is associated with the biometric information for the user). The hub computer 20 may accomplish the tagging or appending of the user's biometric information and/or user identification information to the data collected from the measurement devices 50, 60. The information from the measurement devices 50, 60 and the tagged biometric information and/or user identification information may then be sent over a wired or wireless connection to the remotely located health monitoring data center 70, where it may be stored in a user health database 80 and displayed on one or more monitors 90. The information from the measurement devices and the tagged biometric information and/or user identification information may be encrypted within the hub 10 before transmission to the data center 70, or it may be transmitted in cleartext form.

The data center 70 may associate the received measurement data for the user, tagged with biometric information and/or a user identifier, with the particular user to which the information pertains. For example, the data center 70 may utilize the look-up table to associate the received user identifier and/or biometric information with that particular user's name, number or other identifying characteristics stored in database 80, thereby identifying the user by name, number, etc. The received measurement data for that particular user may thus be associated with that person's name, number or other identifying characteristics and may be displayed on the monitor(s) 90. Furthermore, the received information for a particular user may include a unique hub identifier, which identifies the particular hub from which the information is received. The data center 70 may thus determine which hub, in a system with a plurality of hubs, originated the particular measurement.

As described, the process of associating the measured health parameters (i.e. by the measurement devices 50, 60) with the particular user or patient's name, number, or other identifying characteristics may be entirely contained within the health monitoring data center 70. As such, patient privacy is preserved as the user's name, number, or any other potentially sensitive information is never transmitted over the wired or wireless link.

The hub 10 may tag only one of the unique user identifier or the biometric information to the user's measured health information. Transmitting only the locally unique user identifiers with each measurement is less expensive in terms of network bandwidth than transmitting the entire Identification Vector (IV) (i.e., the entire biometric identification information) with each measurement. To allow the identification of a particular user with a local user identifier (e.g., a sequence number unique to the specific hub 10) to be preserved even if the hub 10 is damaged, the IV along with the local user identifier may initially be transmitted to the data center 70, and thus can be restored at a later time, either to the same hub or to a replacement hub.

After the user has finished taking health measurements, the user may log out of the hub 10 utilizing the biometric sensor 30. For example, the user may terminate the session by placing his/her finger over the fingerprint scanner, in the case where the biometric sensor 30 is a fingerprint scanner. Alternatively, a user session may be terminated by any known log out techniques, such as a programmed time-out, or by using an input device to log out of the hub 10.

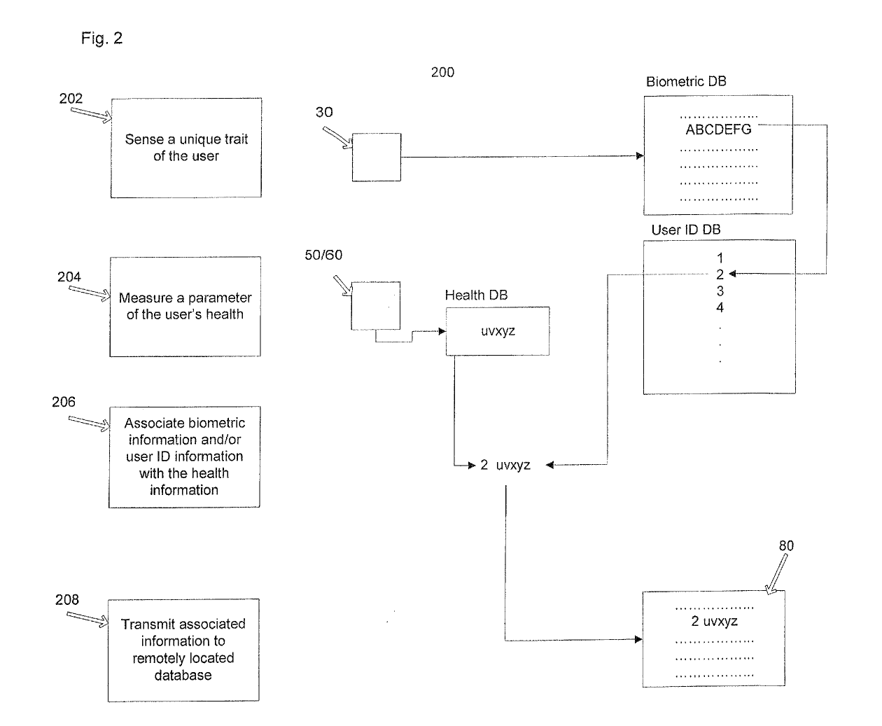

FIG. 2 is a flow diagram 200 illustrating a method of remotely monitoring a user's health, utilizing the system of FIG. 1, in accordance with an embodiment of the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As shown by block 202, a unique trait of the user is sensed by the biometric sensor 30. This may be accomplished, for example, by sensing the user's fingerprints, retinal characteristics, voice, or the like. The sensed biometric information (e.g., represented by “ABCDEFG” in FIG. 2) may be stored in a biometric information database within memory 24. Furthermore, the biometric information may be associated with a user identifier (e.g., represented by “2” in FIG. 2), which may be stored in a user identification database in computer memory 24. The user identifier may be automatically assigned by the computer 20.

At block 204, at least one measurement device (e.g., scale 50 and/or blood pressure monitor 60) measures a parameter of the user's health. The measured health information (e.g., represented by “uvxyz” in FIG. 2) may be stored in a health information database within memory 24.

At block 206, the computer 20 associates the biometric information and/or the user identification information with the measured health information. As shown in the example of FIG. 2, the computer 20 tags the user identification information (e.g., “2”) onto the measured health information (e.g., “uvxyz”).

At block 208, the computer 20 transmits the associated user identification information and the measured health information to a remotely located database 80. The information may be transmitted over any wired or wireless network. The database 80, which may be located within a health monitoring data center 70, receives the transmitted information (e.g., “2uvxyz”) and may store this information. The information may be decoded by the data center 70, as the data center 70 may store information which associates the user identification information and/or the biometric information with the user's name, number or other identification information. The data center 70 may thus display on monitors 80 the user's name, number or other identification information along with the measured health information for that particular user.

The data center 70 may be located, for example, in any location where it may be monitored by a physician, nurse, or other medical personnel.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of the present disclosure and protected by the following claims.

1. A multiuser health monitoring hub, comprising:
a computer;
a biometric sensor for sensing a unique trait of a user; and
at least one measurement device for measuring at least one parameter of the user's health,
wherein the computer is configured to receive biometric information relating to the user from the biometric sensor and health information relating to the user from the at least one measurement device and to associate the received biometric information with the received health information.

2. The monitoring hub of claim 1, wherein the computer is further configured to associate the biometric information relating to the user with a user identifier that is unique to the hub, and to associate the user identifier with the health information relating to the user.

3. The monitoring hub of claim 2, wherein the user identifier is automatically assigned by the computer.

4. The monitoring hub of claim 2, wherein the computer is further configured to transmit the associated user identifier and health information to a database located remote from the hub.

5. The monitoring hub of claim 4, wherein the central database is located remote from the monitoring hub.

6. The monitoring hub of claim 1, wherein the biometric sensor comprises a fingerprint scanner or a retinal scanner.

7. The monitoring hub of claim 1, wherein the biometric sensor comprises a voice recognition device.

8. The monitoring hub of claim 1, wherein the at least one measurement device comprises one or more of: a weight scale, a blood pressure monitor, a respiratory rate monitor, a heart rate monitor, a pulse oximeter, a vision measurement device, and a blood glucose monitoring device.

9. A multiuser remote health monitoring system, comprising:
a multiuser health monitoring hub having a computer;
a biometric sensor for sensing a unique trait of a user;
at least one measurement device for measuring at least one parameter of the user's health; and
a database located remote from the hub,
wherein the computer is configured to receive biometric information relating to the user from the biometric sensor and health information relating to the user from the at least one measurement device and to associate the received biometric information with the received health information, and
wherein the computer is configured to transmit the associated biometric and health information relating to the user to a database located remote from the hub.

10. The system of claim 9, wherein the computer is further configured to associate the biometric information relating to the user with a user identifier that is unique to the hub, and to associate the user identifier with the health information relating to the user.

11. The system of claim 10, wherein the user identifier is automatically assigned the computer.

12. The system of claim 10, wherein the computer is configured to transmit the associated user identifier and health information to the remotely located database.

13. The system of claim 12, wherein the database is configured to store the user's name, and to associate the user's name with the user identifier.

14. The system of claim 9, wherein the biometric sensor comprises a fingerprint scanner or a retinal scanner.

15. The system of claim 9, wherein the biometric sensor comprises a voice recognition device.

16. The system of claim 9, wherein the at least one measurement device comprises one or more of: a weight scale, a blood pressure monitor, a respiratory rate monitor, a heart rate monitor, a pulse oximeter, a vision measurement device, and a blood glucose monitoring device.

17. A method of remotely monitoring a person's health, comprising:
sensing a unique trait of the person, utilizing a biometric sensor;
measuring at least one parameter of the person's health with at least one measurement device;
receiving, by a computer, biometric information sensed by the biometric sensor and health information measured by the at least one measurement device;
associating, by the computer, the received biometric information with the received health information; and
transmitting the associated biometric and health information to a remotely located database.

18. The method of claim 17, wherein the computer is further configured to associate the received biometric information with a unique user identifier, and to associate the user identifier with the health information relating to the user.

19. The method of claim 18, wherein the user identifier is automatically assigned by the computer.

20. The method of claim 18, wherein the computer is further configured to transmit the associated user identifier and health information to the remotely located database.

21. The method of claim 20, further comprising:
storing the user's name in the database;
associating the user's name, in the database, with the user's identifier.

22. The method of claim 17, wherein the biometric sensor comprises a fingerprint scanner or a retinal scanner.

23. The method of claim 17, wherein the biometric sensor comprises a voice recognition device.

24. The method of claim 17, wherein the at least one measurement device comprises one or more of: a weight scale, a blood pressure monitor, a respiratory rate monitor, a heart rate monitor, a pulse oximeter, a vision measurement device, and a blood glucose monitoring device.

25. A non-transitory computer readable medium containing instructions for providing remote monitoring of a person's health, wherein a unique trait of a person is sensed using a biometric sensor, and at least one parameter of a person's health is measured with at least one measurement device, and wherein biometric information sensed by the biometric sensor and health information measured by the at least one measurement device, is received by the computer, the instructions, which when executed by the computer, performing the steps of associating, by the computer, the received biometric information with the received health information; and transmitting the associated biometric health information to a remotely located database.

26. The non-transitory computer readable medium of claim 25, wherein the instructions cause the computer to associate the received biometric information with a unique user identifier, and to associate the user identifier with the health information relating to the user.

27. The non-transitory computer readable medium of claim 25, wherein the instructions cause the computer to automatically assign the user identification.

28. The non-transitory computer readable medium of claim 25, wherein the instructions cause the computer to transmit the associated user identifier and health information to the remotely located database.

29. The non-transitory computer readable medium of claim 28, wherein the instructions cause the computer to
store the user's name in the database; and
associate the user's name, in the database, with the user's identifier.
